(19) United States
(12) Patent Application Publication
(10) Pub. No.: US 2003/0058105 A1
(43) Pub. Date: Mar. 27, 2003

(54) Light fence with beam divider

(75) Inventors: Martin Wuestefeld, Sexau (DE); Olaf Henkel, Reute (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 10/251,546

(22) Filed: Sep. 19, 2002

(30) Foreign Application Priority Data
Sep. 21, 2001 (DE) 10146639.0

(51) Int. Cl. G08B 13/18; G01J 1/42

(52) U.S. Cl. 340/556; 250/227.14

(57) ABSTRACT

An optic-electronic arrangement to prevent access to or detect objects approaching a protected zone. An emitter/receiver unit is positioned on one side of the zone and an opposing, passive reflector unit is positioned at the other side of the zone. Emitted light is directed from one side of the zone to the other side along a control distance and is divided into a plurality of spatially spaced apart reflected beam portions that extend along the control distance and are detected by sensors in the emitter/receiver unit for further processing.

### BACKGROUND OF THE INVENTION

The present invention relates to an optical-electronic arrangement for detecting objects entering a protected zone or area. An active emitter/receiver unit is placed on one side of the protected zone and a passive reflector unit is positioned on the other side of the zone opposite the emitter and receiver unit.

Such optic-electronic systems are used, for example, to control access to the area of a machine in a manner similar to a light barrier. The active components, such as the light emitter, light sensor, signal processing unit and the like are arranged in a common housing that is positioned at one side of the area or zone to be controlled. Opposite the emitter/receiver unit and on the other side of the control zone is a light reflector which returns emitted light to a light sensor in the emitter/receiver unit after the light has traversed the control zone. The light reflector is a passive reflector and reflects the light from the emitter back to the sensor. Depending on the particular arrangement, it is necessary that several spatially offset light beams be arranged as a light fence to make sure that all objects that enter the protected zone are detected and to prevent against the possibility that objects might pass the light fence undetected.

Such an arrangement is known from German patent 199 25 553. It discloses two light emitters which release light pulses that are offset in time and following their reflection by a reflecting unit, they are directed to a common light sensor. To send both light beams to the same sensor, a switching arrangement is needed which sends a geometric half cross section of the beam from the first light emitter and the complementary half light beam cross section from the second emitter to the common light sensor. To assure that the two light paths have the approximately same energy, a relatively precise alignment of the two light beams relative to the switching arrangement is necessary. In addition, the reflector requires at least four mirrors which must be precisely aligned with respect to each other which is difficult to do and costly. In order for this arrangement to work properly, it is necessary that the two light emitters do not simultaneously release light pulses and instead release them at different times. This has the disadvantage that the emissions from the two light sources require relatively more time which makes short, rapid pulse rates impossible. This can also be a disadvantage when the arrangement is subject to heavy background radiation.

Another arrangement of this type is disclosed in German patent 39 39 191. It discloses an arrangement in which several one-way light barriers are assembled into a light fence. A first housing on one side of the control zone contains several adjacent light emitters. A second housing on the opposite side of the control zone has several light sensors which correspond to the light emitters. Each emitter thus forms a light barrier with its opposite light sensor. These cooperating pairs are sequentially activated and in this manner detect objects in a control plane. A disadvantage of this arrangement is that both housings require a supply of electricity. In addition, an electrical or optical synchronization between the spatially separated individual pairs is needed so that the corresponding emitters and sensors are simultaneously activated.

### BRIEF SUMMARY OF THE INVENTION

It is an object of this invention to provide an arrangement of the above-described type which goes beyond the state of the art as it previously existed and which can be realized with only a few active components that are mounted in a single housing on one side of the control zone and which does not require critical adjustments to operate properly.

This is obtained by directing the light emitted by the emitter/receiver unit to a reflector that divides the beam into a plurality of spatially separate beam portions and by providing a light sensor in the emitter/receiver unit for each beam portion.

The arrangement of the present invention has at least one light emitter and at least two light sensors. The emitter sends a light beam towards the control zone. If the beam is not interrupted by an object, it impinges on a reflector at the other side of the control zone. The reflector divides the incoming light beam into at least two beam portions which have different spacings from the emitted light beam and which reflect the partial beams in the opposite direction across the control zone. The offset beam portions strike the light sensors, which are offset from the emitted beam by the same amounts as the beam portions and which convert the received light into electric values or signals.

Due to the differing offsets between the emitted light beam and the reflected beam portions, the control zone is traversed by at least three different beams. In this manner, the present invention performs the function of a light fence with three beams.

A particular advantage of the present invention is that three beams can be generated with only one emitter and two sensors, instead of three emitters and three sensors that were required in the past. In addition, the three beams are simultaneously activated and need not be staggered in time by sequentially activating them. required in the past. In addition, the three beams are simultaneously activated and need not be staggered in time by sequentially activating them.

### BRIEF DESCRIPTION OF THE DRAWINGS

FIG. 1 schematically illustrates an optic-electronic system constructed in accordance with the invention employing three light beams;

FIG. 2 schematically illustrates such a system employing four light beams; and

FIG. 3 is a schematic, perspective illustration of another aspect of the present invention employing three light beams.

### DESCRIPTION OF THE PREFERRED EMBODIMENTS

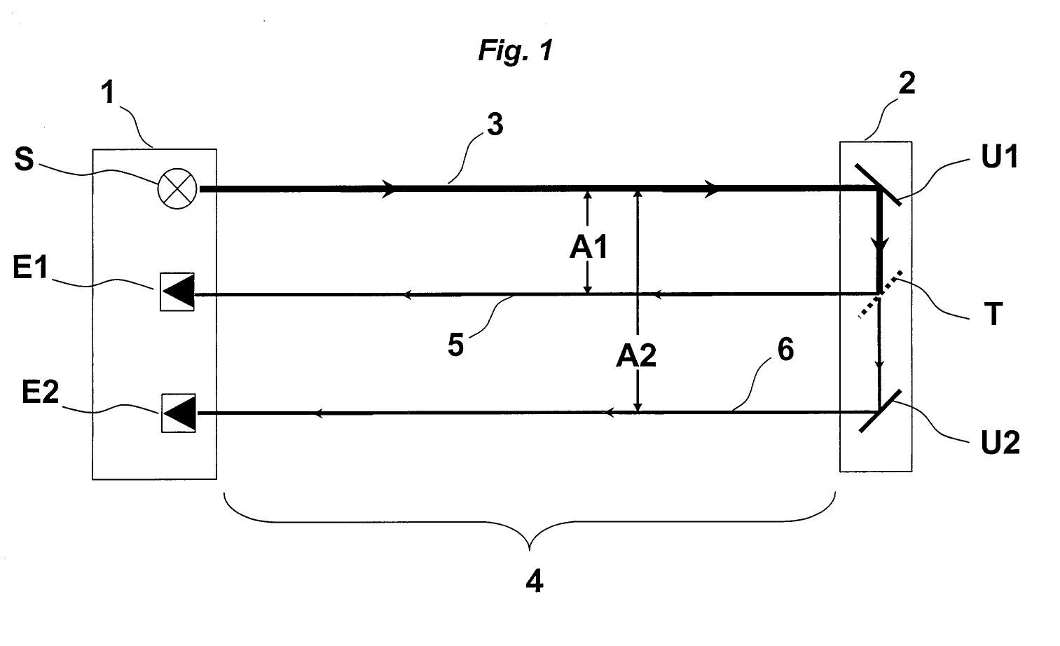

Referring to FIG. 1, an emitter/receiver unit 1 houses a light emitter S which emits a narrow, slightly diverging emitted light beam 3 towards a reflector unit 2 over a control distance or zone 4. The emitted light beam 3 strikes a reflecting mirror U1 in reflector unit 2 at an angle of 45°. The reflecting mirror deflects the emitted light beam by 90° in a direction towards beam splitter T. Beam splitter T is also at an angle of 45° to the light beam received by it and it has the characteristic of transmitting a portion of the beam (preferably 50%) of the received light beam without changing its direction while it reflects the remaining part of the beam at an angle of 90°. The reflected partial beam 5 is offset from the emitted beam 3 by a distance A1 and after traversing the control distance 4, it is received by light sensor E1. The transmitted partial beam 6 strikes a reflecting mirror U2 at 45° which redirects the beam, offset from the emitted beam by a distance A2, to a second light sensor E2. Since reflecting mirror U1 forms an angle of 90° with beam splitter T and reflecting mirror U2, respectively, partial beam 5 as well as partial beam 6 extend in the plane of FIG. 1 parallel to emitted light beam 3. This is the case even if reflector unit 2 is slightly rotated relative to an axis (not shown in the drawings) that is perpendicular to the plane of FIG. 1.

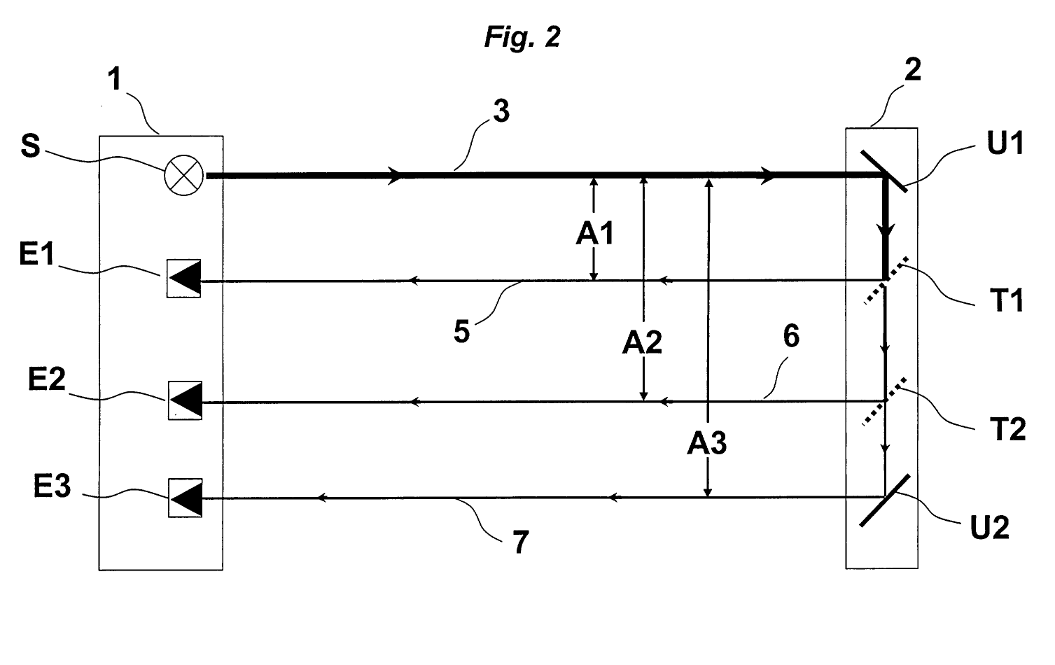

FIG. 2 shows an arrangement with four beams. At first beam splitter T1, which is positioned at an angle of 45° with respect to the incoming light beam, reflects approximately one-third of the light from emitted light beam 3 towards light sensor E1 at a distance A1 from the emitted light beam and parallel thereto. The remaining light of the incoming light beam 3 is transmitted by beam splitter T1 and reaches a second beam splitter T2. Beam splitter T2, similar to beam splitter T shown in FIG. 1, transmits and reflects, respectively, approximately equal portions of the light reaching the second beam splitter. Following a further reflection at a second reflecting mirror U2, a transmitted, partial light beam 7 is offset relative to the emitted light beam 3 by a distance A3 and reaches light sensor E3 after it has traversed the control zone. A further partial light beam 6, offset relative to the emitted light beam 3 by a distance A2, it is reflected by the second beam splitter T2 and received by light sensor E. As a result, with an unobstructed control zone, the light sensors receive approximately equal light energy, which is desirable for subsequent signal processing.

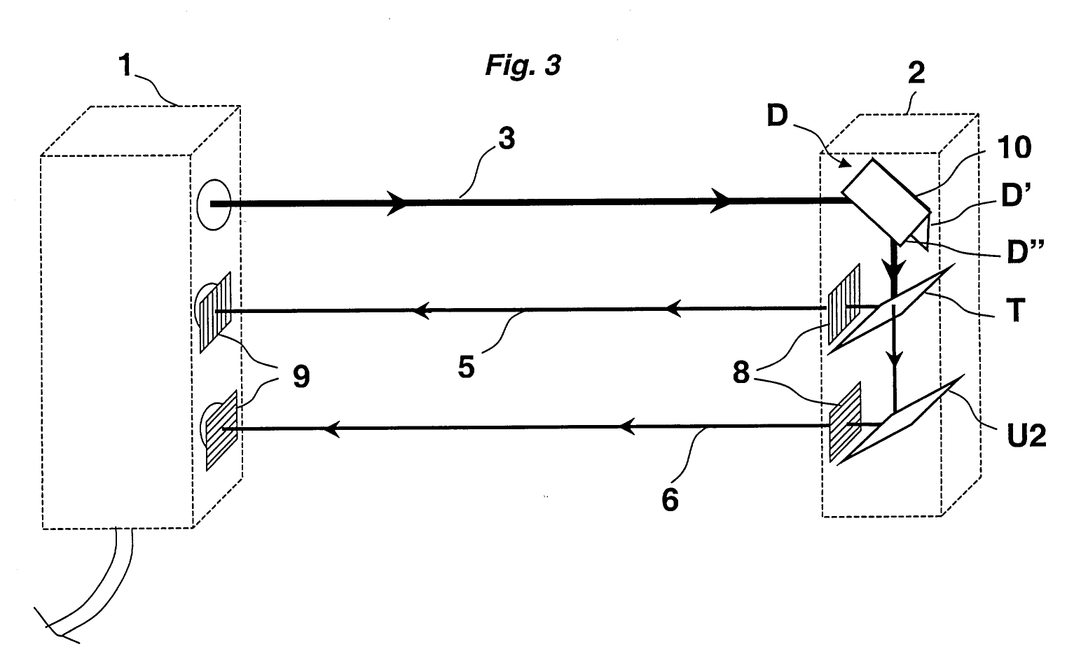

FIG. 3 shows an advantageous further aspect of the present invention which employs three beams. Reflector unit 2 has a first reflecting mirror D that is roof-shaped. Mirror D is formed by two planar mirrors D′, D″ which are arranged at an angle of 90° with respect to each other. The two planar mirrors intersect along a line 10 which is arranged at an angle of 45° to emitted light beam 3. The mirror surfaces of planar mirrors D′, D″ face the emitted light beam 3 so that the light beam strikes the mirror on one of the two planar mirror surfaces and preferably so that it partially strikes both mirror surfaces. Since each partial beam in reflector unit 2 is again deflected by 90° at beam splitter T, or by reflecting mirror U2, each light beam undergoes three directional changes in an arrangement employing roof-shaped mirror D. Since the three direction changes are caused by three mirror surfaces which are inclined with respect to each other by an angle of 90°, a special retroreflection is obtained in the manner of a triple mirror. Such a retroreflection has the advantage that the emitted light beam 3 and the partial beams 5, 6 are parallel to each other. This eliminates the need for a precise alignment between the deflector unit and the emitter/receiver unit.

FIG. 3 also shows the positioning of a polarizing filter 8 at the exit (in front of) reflector unit 2 and a corresponding polarization filter aligned in front of emitter/receiver unit 1. The polarizing filters are arranged so that, for example, partial beam 5 permits the passage of only horizontally polarized light while the polarization filter intersecting partial beam 6 permits passage of only vertical components of the light to thereby segregate the two beams.

“Light” as used in this application is not limited to visible light and includes other wavelengths on either side of the visible spectrum, that is ultraviolet as well as infrared light. In addition, the present invention is usable with all types of constant and variable light.

What is claimed is:

1. An arrangement for detecting objects entering a protected zone having spaced apart, first and second sides and a control zone in between, the arrangement comprising an active emitter/receiver unit located on one side of the zone and a passive deflector unit at the other side of the zone, the reflector unit including a light diverting device which divides a light beam emitted by the emitter/receiver unit into a plurality of spaced apart, partial reflected beams, the emitter/receiver unit including a light sensor for each partial beam positioned so that each partial beam strikes a corresponding light sensor.

2. An arrangement according to claim 1 wherein the respective light sensors are activated at different times for receiving the partial beams.

3. An arrangement according to claim 1 wherein a distance of one of the partial reflected light beams from one of the emitted light beam and the other one of the partial light beams is adjustable.

4. An arrangement according to claim 1 wherein the reflector unit includes beam splitters for dividing the emitted light beam into the partial reflected light beams.

5. An arrangement according to claim 4 wherein a ratio between reflection and transmission of light by the beam splitter is selected so that the light energy in the reflected partial beams is approximately equal.

6. An arrangement according to claim 1 wherein the reflector unit includes a roof-shaped mirror comprising first and second, angularly inclined mirror portions which are positioned so that the emitted light beam from the emitter/receiver unit strikes the roof-shaped mirror.

7. An arrangement according to claim 6 wherein the roof-shaped mirror comprises a roof-shaped prism.

8. An arrangement according to claim 1 including an optical device placed at the emitter/receiver unit for shaping the light beams.

9. An arrangement according to claim 1 including a polarizing filter positioned to intercept the reflected partial light beams to prevent reflected partial beams from interfering with each other.
